(19) United States
(12) Patent Application Publication
(10) Pub. No.: US 2002/0054575 A1
(43) Pub. Date: May 9, 2002

(54) Data communication system for compensating the attenuation of transmission signal

(76) Inventor: Gyu Hyeong Cho, Daejeon (KR)

Correspondence Address: BACON & THOMAS, PLLC, 625 SLATERS LANE, FOURTH FLOOR, ALEXANDRIA, VA, 22314

(21) Appl. No.: 09/982,171

(22) Filed: Oct. 19, 2001

(30) Foreign Application Priority Data
Nov. 6, 2000 (KR) 2000-65465

(51) Int. Cl. H04B 3/20

(52) U.S. Cl. 370/287; 370/288; 379/347; 379/403

(57) ABSTRACT

In a data communications system, a first node transmits an output digital signal to a second node through a transmission line and receives an input digital signal from the second node through a reception line, a signal processing amplification block of the data communications system compensates an attenuation in the input digital signal and prevents a crosstalk between the transmission line and the reception line, and a regulating block for preventing a crosstalk receives a branch signal and generates a control signal based on a capacity of the branch signal.

### FIELD OF THE INVENTION

The present invention relates to a data communications system; and, more particularly, to a data communications system for compensating the attenuation of digital signals transmitted through a transmission line in LAN (Local Area Network).

### BACKGROUND OF THE INVENTION

The use of the Internet to access information is increasing rapidly. Accordingly, various apparatuses such as LAN and xDSL system have been developed for a fast and safe transmission of the information to a remote computer.

Referring to FIG. 1, there is shown a conventional 4-wire data communications system used in LAN. The data communications system includes a main unit 1, a hub 2, two pairs of transmission lines 3 and 4 and a PC 5. As shown in FIG. 1, the main unit 1 is connected to an external network and communicates with the PC 5 through the hub 2 and two pairs of transmission lines 3 and 4. The hub 2 is connected to a LAN card (not shown) of the PC 5 through two pairs of transmission lines 3 and 4. Two pairs of transmission lines are twisted pairs of wires such as UTP (unshielded twisted pair) wires.

The conventional LAN system enables the data communications to be carried out at a transmission speed up to 10 Mbps within a distance of approximately 200 m. However, if the distance is over approximately 200 m, the transmission speed becomes noticeably decreased. In addition, the twisted lines commonly used in a LAN have an electrical characteristic that they exhibit higher attenuation of signals transmitted through the lines as frequencies of the signals are getting higher. Therefore, when a signal, particularly, a high frequency signal, is transmitted through a long haul, the signal has to be amplified in transit.

If an amplifier designed for the long haul communication is used in short haul communication of LAN, the amplifier will over-emphasize some higher frequencies of the data signal, which causes a crosstalk between transmission lines. Therefore, there is a need for a data communications system which compensates the attenuation of signals transmitted through a transmission line by adaptively amplifying the signals, without suffering from the overemphasizing problem of the signals.

### SUMMARY OF THE INVENTION

It is, therefore, a primary object of the present invention to provide a data communications system, especially, a LAN system, for compensating digital signals transmitted through a transmission line.

It is another object of the present invention to provide an apparatus for preventing a crosstalk that disables the data communications system.

In accordance with a preferred embodiment of the present invention, there is provided a data communications system including:

a first node for transmitting an output digital signal to a second node through a transmission line and receiving an input digital signal from the second node through a reception line, wherein the first node having a transmission port for transmitting the output digital signal and a reception port for receiving the input digital signal; and

a signal processing amplification block for compensating an attenuation of the input digital signal and preventing a crosstalk between the transmission line and the reception line, wherein an input port of the signal processing amplification block is connected to the second node through the reception line and an output port of the signal processing amplification block is connected to the reception port.

In accordance with another embodiment of the present invention, there is provided a data communications system including:

a first node for transmitting an output digital signal to a second node through a transmission line and receiving an input digital signal from the second node through a reception line, wherein the first node having a transmission port for transmitting the output digital signal and a reception port for receiving the input digital signal;

an amplification device for amplifying the input digital signal, wherein an input port of the amplification device is connected to the second node through the reception line and an output port of the amplification device is connected to the reception port; and

a regulating block, coupled to the amplification device, for generating a control signal to alter an amplification gain of the amplification device, to thereby prevent a crosstalk between the transmission line and the reception line.

### BRIEF DESCRIPTION OF THE DRAWINGS

The above and other objects and features of the present invention will become apparent from the following description of preferred embodiments given in conjunction with the accompanying drawings, in which:

FIG. 1 shows a conventional 4-wire data communications system;

FIG. 2 describes a block diagram of a 4-wire data communications system in accordance with a first preferred embodiment of the present invention;

FIG. 3A illustrates a block diagram of the download signal processing amplifier shown in FIG. 2 in accordance with the first preferred embodiment of the present invention;

FIG. 3B represents a block diagram of another download signal processing amplifier in accordance with a second preferred embodiment of the present invention;

FIG. 4A shows a detailed block diagram of the 4-wire data communications system in accordance with the first preferred embodiment of the present invention;

FIG. 4B offers a detailed block diagram of the 4-wire data communications system in accordance with the second preferred embodiment of the present invention;

FIG. 5A is a detailed block diagram of the 4-wire data communications system in accordance with a third preferred embodiment of the present invention;

FIG. 5B provides a detailed block diagram of the 4-wire data communications system in accordance with a fourth preferred embodiment of the present invention;

FIG. 6A sets forth a detailed block diagram of the 4-wire data communications system in accordance with a fifth preferred embodiment of the present invention;

FIG. 6B shows a detailed block diagram of the 4-wire data communications system in accordance with a sixth preferred embodiment of the present invention;

FIG. 7A depicts a detailed block diagram of a 2-wire system in accordance with a seventh preferred embodiment;

FIG. 7B is a detailed block diagram of a 2-wire system in accordance with an eighth preferred embodiment;

FIG. 8 illustrates a circuit diagram of the phase compensation amplifier shown in FIG. 3A;

FIG. 9 presents another circuit diagram of the phase compensation amplifier shown in FIG. 3A;

FIG. 10A exemplifies a circuit diagram of the limiter shown in FIG. 3A;

FIG. 10B describes a circuit diagram of the limiter shown in FIG. 3B;

FIG. 11 is a circuit diagram of the regulating block shown in FIG. 3A;

FIG. 12 offers a circuit diagram of the control block shown in FIG. 3B;

FIG. 13 represents a circuit diagram of the signal combination block shown in FIG. 3B; and

FIG. 14 shows a circuit diagram of the output signal amplification block in accordance with the present invention.

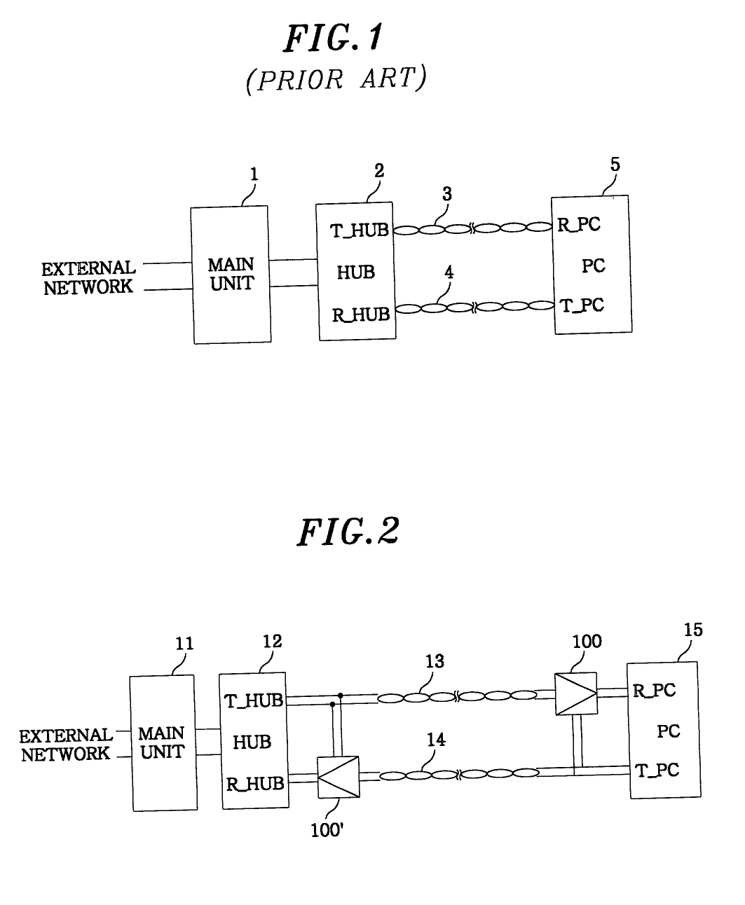

### DETAILED DESCRIPTION OF THE PREFERRED EMBODIMENTS

FIG. 2 shows a block diagram of a 4-wire data communications system in accordance with a first preferred embodiment of the present invention. The 4-wire data communications system includes a main unit 11, a hub 12, a 4-wire transmission line, a PC 15, a download and an upload signal processing amplifiers 100 and 100′.

The main unit 11 is connected with an external network to communicate and exchange information therewith, wherein the information is a digital signal. The main unit 11 is also connected to the hub 12, so as to forward the information to the PC 15. Hereinafter, the information forwarded to the PC 15 from the main unit 11 is referred to as a download signal.

The hub 12 connected to the main unit 11 intermediates communication between the main unit 11 and the PC 15. The hub 12 has a transmission port T_HUB for sending download signals to the PC 15 and a reception port R_HUB for receiving upload signals, the upload signals being digital signals generated from the PC 15.

The PC 15, a conventional subscriber, has a transmission port T_PC for sending the upload signals to the main unit 11 and a reception port R_PC for receiving the download signals from the main unit 11.

Wires in the 4-wire transmission line are grouped into two channels, each of which is composed of two wires. One channel is a download transmission line 13 for delivering the download signals from T_HUB to R_PC. And the other channel is an upload transmission line 14 for sending the upload signals from T_PC to R_HUB.

The download and the upload signal processing amplifiers 100 and 100′ are employed on the channels to perform smoothly and exactly data communication in the 4-wire data communications system. It is possible to carry out the data communication within or beyond the distance of 500 m by employing the download and the upload signal processing amplifiers 100 and 100′ at receiving ends of transmission lines in accordance with the present invention.

The transmission lines 13 and 14 have a characteristic that the attenuation in high frequency signals is typically greater than that in low frequency signals. In order to compensate the attenuation in high frequency signals, the download and the upload signal processing amplifiers 100 and 100′ are installed on each receiving end of the transmission lines 13 and 14.

The download and the upload signal processing amplifiers 100 and 100′ carry out various functions for compensation such as amplification and limitation, to thereby enable the data communication to be performed within the distance not exceeding about 1 km without increasing a transmission power of the system.

Hereinafter, architectures and functions of the download and the upload signal processing amplifiers 100 and 100′ will be explained in detail. For the simplicity of the explanation, only the download signal processing amplifier 100 is explained. However, it should be noted that architectures and functions of the upload signal processing amplifier 100′ are same as those of the download signal processing amplifier 100.

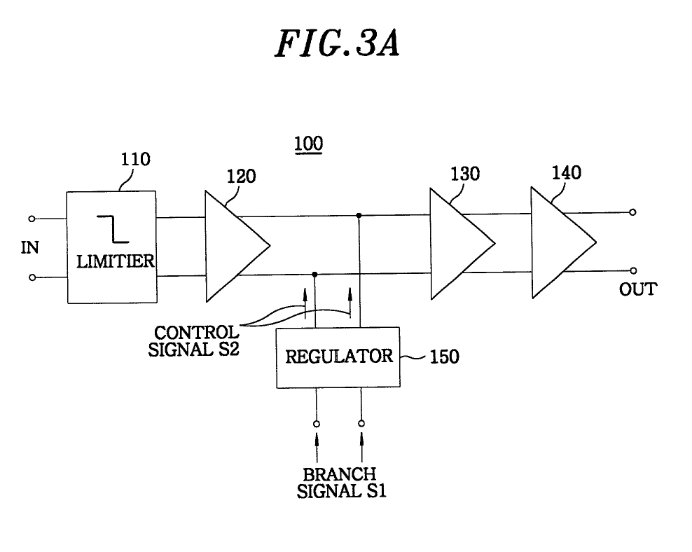

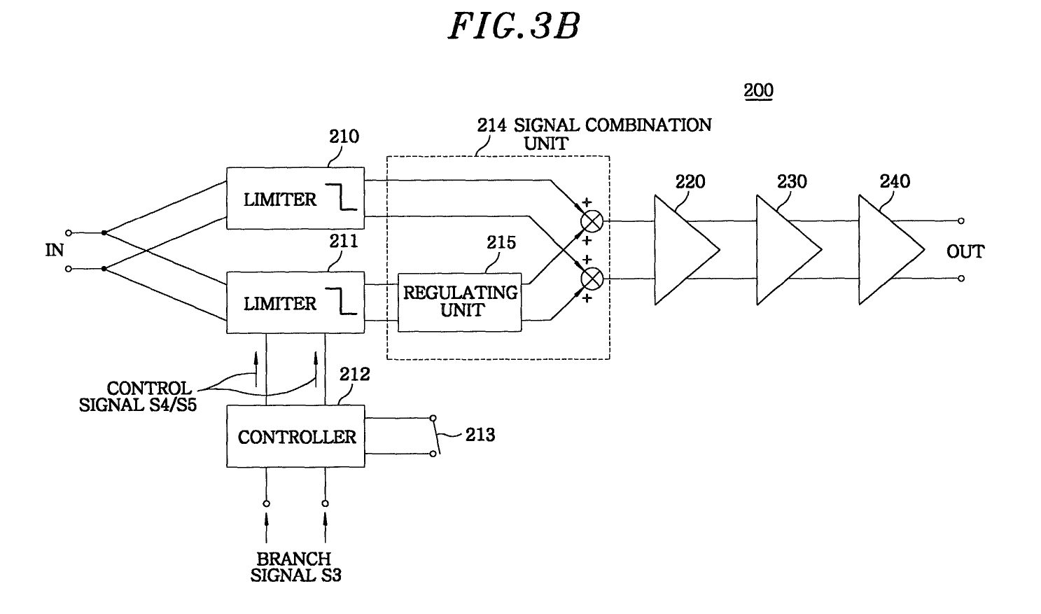

FIG. 3A shows a block diagram of the download signal processing amplifier 100 of FIG. 2 in accordance with the first preferred embodiment of the present invention. The download signal processing amplifier 100 includes a limiter 110, a plurality of phase compensation amplifiers 120, 130 and 140 and a regulator 150.

First, the phase compensation amplifiers 120, 130 and 140 are explained.

Since the transmission lines have a characteristic that the attenuation in high frequency signals is greater than that in low frequency signals, the download signals, particularly, high frequency signals thereof, may be noticeably attenuated in the transmission line in transit. In order to compensate the attenuation in the download signals provided from a previous stage, the phase compensation amplifier 120 amplifies the download signals provided thereto based on the frequencies of the download signals.

However, if the download signals are excessively amplified, the PC 15 cannot correctly recognize original information. Therefore, the download signal processing amplifier 100 sets further limits on the amplitude of the download signal inputted thereto.

These limitations and the amplification procedures enable the high frequency signal to be sufficiently and adequately amplified, to thereby compensate the attenuation of the download signals due to the characteristic of the transmission lines.

Herein, the phase compensation amplifiers 130 and 140 are the same circuits as the phase compensation amplifier 120 and each performs an operation similar to that of the phase compensation amplifier 120.

As mentioned above, the download signal processing amplifier 100 amplifies and limits the download signals. Although the download signals are processed in the phase compensation amplifier 120, it is preferable to prevent the download signals from over-amplification in advance. Accordingly, the limiter 110 modifies the download signals before entering the phase compensation amplifier 120. The limiter 110 examines whether the amplitude of the download signals is within a predetermined range. If the amplitude of the download signals falls within the predetermined range, the limiter 110 passes the download signals to a subsequent stage without any change; if otherwise, the limiter 110 clamps the download signals to make them fall within the predetermined range and then sends the clamped signals to the subsequent stage.

Meanwhile, the 4-wire data communications system is classified into either a full duplex mode system or a half duplex mode system depending on whether transmission and reception can be performed simultaneously. The half duplex mode system, which is mostly utilized for the long distance as a timesharing scheme, does not transmit a signal while receiving another signal. On the other hand, the full duplex mode system performs simultaneous reception and transmission. However, a terminal transmitting a signal may detect a noise signal being transmitted to the terminal even in the half duplex mode system. Then the half duplex mode system regards the situation as a collision and stops transmitting the signal.

Since the download and the upload transmission lines 13 and 14 are close to each other, some signals on one pair of transmission lines may interfere with another signal on another pair of transmission lines due to electrostatic coupling between conductors carrying the signals. This type of interference is known as a crosstalk. In such a case, if the download signal processing amplifier 100 is close to the PC 15 and amplification gain of the download signal processing amplifier 100 is designed to be very high, the crosstalk is unexpectedly amplified therein. Then the system misconceives the crosstalk as a collision, to thereby stop transmitting the upload signal. Therefore, the download signal processing amplifier 100 must prepare for the crosstalk and/or the amplification thereof.

The regulator 150 is employed for solving the above problem. The regulator 150 is shunt-connected between the phase compensation amplifiers 120 and 130, and connected to the transmission line 14 as shown in FIG. 2. The regulator 150 generates a control signal S2 on detecting a branch signal S1, e.g., a noise or a portion of the upload signals. The control signal S2 affects the phase compensation amplifiers 130 and 140 to degrade the amplification gain thereof, so that the 4-wire data communications system does not recognize the crosstalk as a collision.

Meanwhile, the download signal processing amplifier 100 can be replaced with another download signal processing amplifier 200 shown in FIG. 3B. Similarly, the upload signal processing amplifier 100′ can be replaced with another upload signal processing amplifier 200′. These download and upload signal processing amplifiers 200 and 200′ are designed to solve problems for the crosstalk in accordance with a second embodiment of the present invention. A block diagram of 4-wire data communications system with the download and the upload signal processing amplifiers 200 and 200′ is not presented because a schematic block diagram thereof is same as that of the 4-wire data communications system including the download and the upload signal processing amplifiers 100 and 100′. Hereinafter, a block diagram of the download signal processing amplifier 200 is explained. In the mean time, it should be noted that architecture and functions of the upload signal processing amplifier 200′ are same as those of the download signal processing amplifier 200.

The download signal processing amplifier 200 includes limiters 210 and 211, a controller 212 having a switch 213, a signal combination unit 214 having a regulating unit 215 and a plurality of phase compensation amplifiers 220, 230 and 240. The download signal processing amplifier 200 processes the download signals through two paths therein: a first path passing through the limiter 210 and a second path passing through the limiter 211. The download signals always pass through the first path, while the second path is conditionally activated depending on states of the limiter 211.

First, on the first path, architectures and functions of the limiter 210 are same as those of the limiter 110 shown in FIG. 3A. That is, the limiter 210 examines the amplitude of input download signals and then delivers them to a next subsequence after clamping or as it is.

On the second path, the limiter 211 is controlled by either control signal S4 or S5 generated from the controller 212. The selection of the control signal S4 or S5 depends on states of the switch 213 and whether or not a branch signal S3 is detected, wherein the switch 213 is generally on state in case of a long haul communication and is off state in case of a short haul communication; and the branch signal S3 is a noise or a portion of the upload signals.

To put it in detail, when the switch 213 is off in case of the short haul communication, the operation of the limiter 211 depends on whether or not the branch signal S3 is detected by the controller 212. That is, if the branch signal S3 is detected, the controller 212 generates the control signal S4 to disenable the limiter 211; if otherwise, the controller 212 generates the control signal S5 to enable the limiter 211 to operate.

On the contrary, in case of the long haul communication, the switch 213 is on. Then the controller 212 generates the control signal S4 to make the limiter 211 disenabled regardless of detection of the branch signal S3. So, the download signals move along only the first path toward the output terminal of the download signal processing amplifier 200. In this state, if amplification gain of the subsequent stage on the first path has been properly adjusted, problems caused by the crosstalk can be easily solved.

Therefore, the amplification gain of the subsequent stage can be considerably degraded when the crosstalk occurs and then the crosstalk is not recognized as the collision even in case of the long haul communication. That is, the limiter 211 enables the 4-wire data communications system to compensate the transmission signals under various conditions.

The signal combination unit 214 having the regulating unit 215 adds the download signals transmitted from the limiters 210 and 211, and sends the added signals to a subsequent stage. The regulating unit 215 modifies an amplification gain for the download signals transmitted from the limiter 211.

The phase compensation amplifiers 220, 230 and 240 are same circuits as the phase compensation amplifier 120 of FIG. 3A and each performs an operation similar to that of the phase compensation amplifier 120.

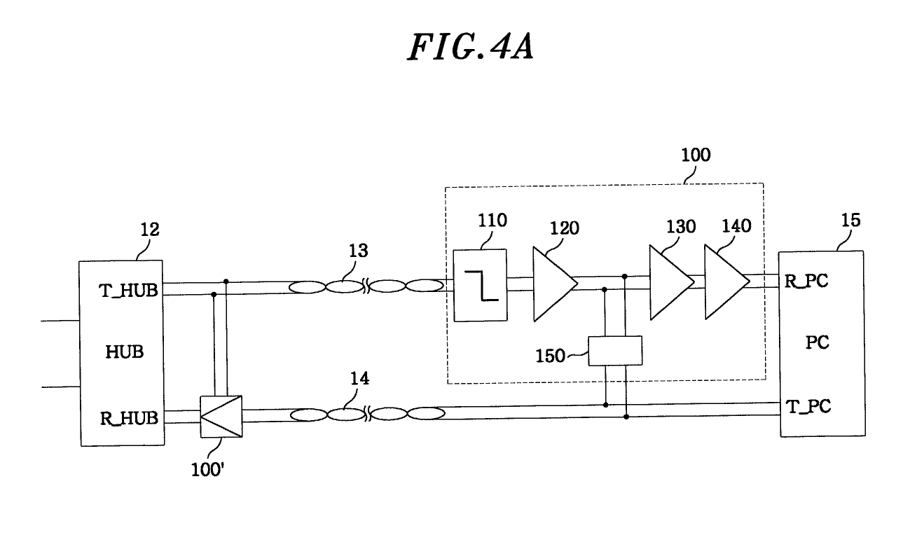

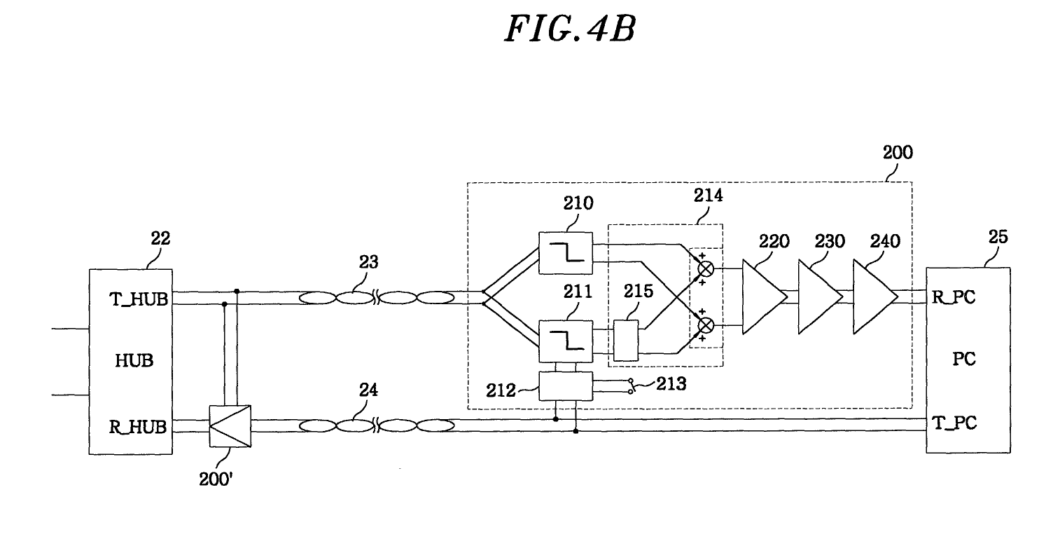

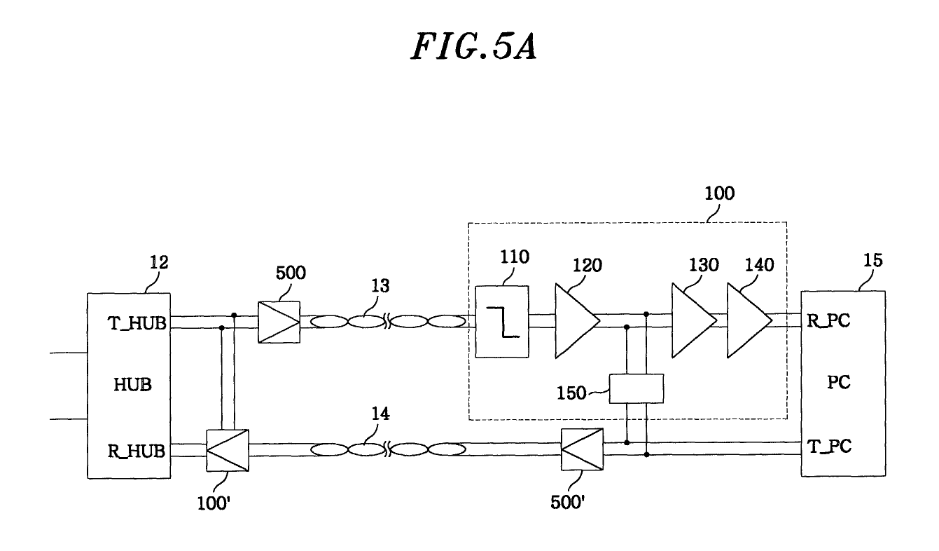

FIG. 4A shows a detailed block diagram of the 4-wire data communications system in accordance with the first preferred embodiment of the present invention, wherein the download signal processing amplifier 100 is represented as the detailed block diagram thereof shown in FIG. 3A. However, the main unit 11 is omitted therein for the simplicity of the explanation, and will be omitted in the accompanying drawings for the same purpose, hereinafter.

The download signal processing amplifier 100 is located at an end of the download transmission line 13 and is linked to the upload transmission line 14 or (but not shown) directly to T_PC. In the download signal processing amplifier 100, its input ports are consistent with the input ports of the limiter 110, and its output ports, which are consistent with output ports of the phase compensation amplifier 140, are connected to T_PC. And, linkage ports thereof are input ports of the regulator 150. Similarly, the upload signal processing amplifier 100′ is located at an end of the upload transmission line 14 and linked to the download transmission line 13 or directly to T_HUB. Therefore, a noise or a portion of the upload signals provided from T_PC is fed to the download signal processing amplifier 100 as the branch signal S1, and a noise or a portion of the download signals provided from T_HUB is fed to the upload signal processing amplifier 100 as the branch signal S1.

FIG. 4B shows a detailed block diagram of the 4-wire data communications system in accordance with the second preferred embodiment of the present invention, wherein the download signal processing amplifier 200 is represented as the detailed block diagram thereof shown in FIG. 3B.

The download signal processing amplifier 200 is located at an end of a download transmission line 23 and is linked to a upload transmission line 24 or (but not shown) directly to T_PC. In the download signal processing amplifier 200, its input ports are divided into two paths, which pass through the limiter 210 and the limiter 211, respectively, and its output ports, which are consistent with output ports of the phase compensation amplifier 240, are connected to R_PC. And, linkage ports thereof are input ports of the controller 212. Similarly, the upload signal processing amplifier 200′ is located at an end of the upload transmission line 24 and linked to the download transmission line 23 or directly to T_HUB. Therefore, a noise or a portion of the upload signals provided from T_PC is fed to the download signal processing amplifier 200 as the branch signal S3, and a noise or a portion of the download signals provided from T HUB is fed to the upload signal processing amplifier 200′ as the branch signal S3.

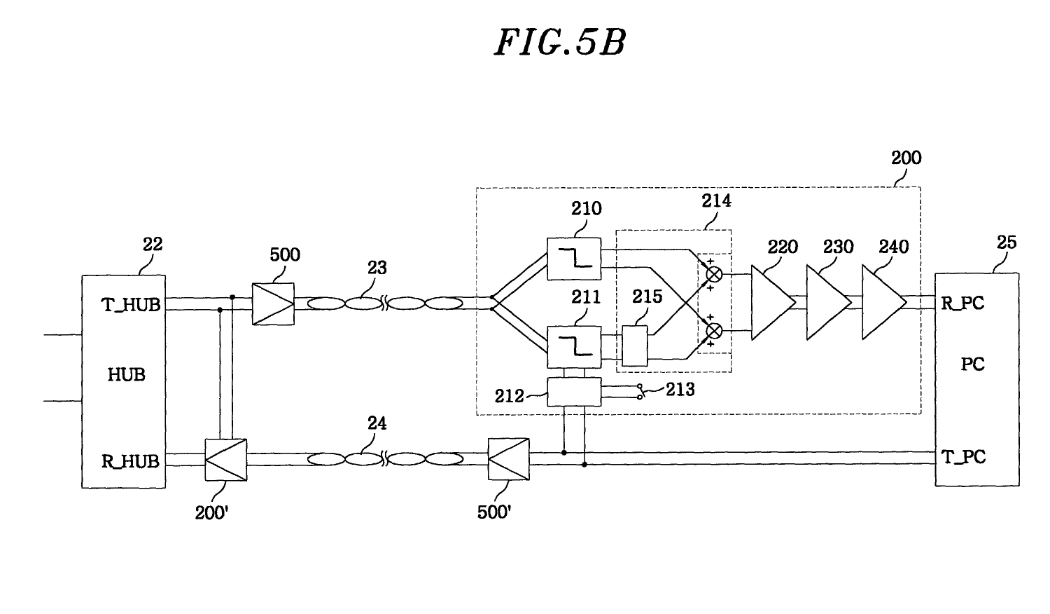

FIG. 5A shows a block diagram of a 4-wire data communications system in accordance with a third preferred embodiment of the present invention. This system further includes two output amplifiers 500 and 500′ in addition to the system shown in FIG. 4A. The output amplifiers 500 and 500′ enable download and upload signals to be transmitted through the long haul communication line by amplifying the download and the upload signals.

The output amplifier 500 is installed on the back of the linkage position, where the upload signal processing amplifier 100′ is linked, in the download transmission line 13. The output amplifier 500′ is similarly installed on the back of the linkage position in the upload transmission line 14.

FIG. 5B represents a block diagram in accordance with a fourth embodiment of the present invention, which is same as the block diagram of FIG. 5A except that the download and the upload signal processing amplifiers 200 and 200′ are substituted for the download and the upload signal processing amplifiers 100 and 100′.

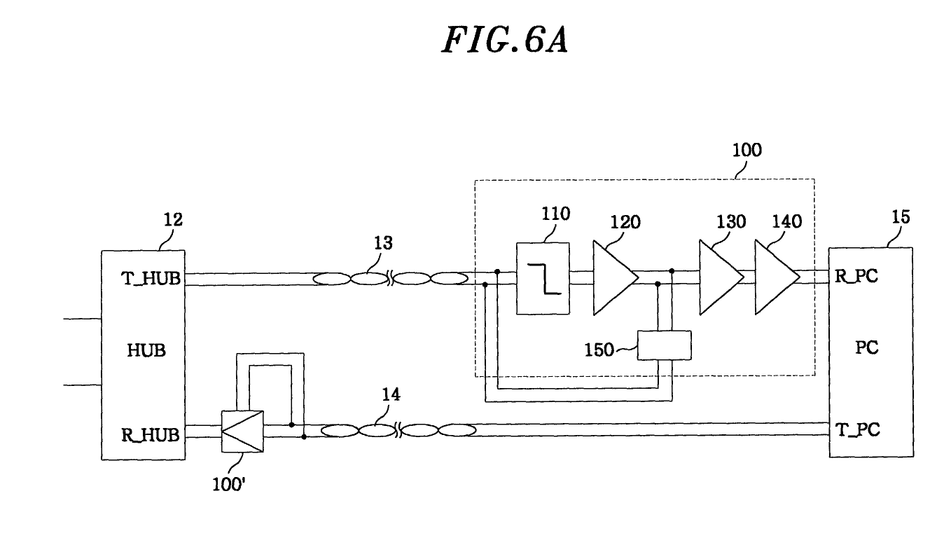

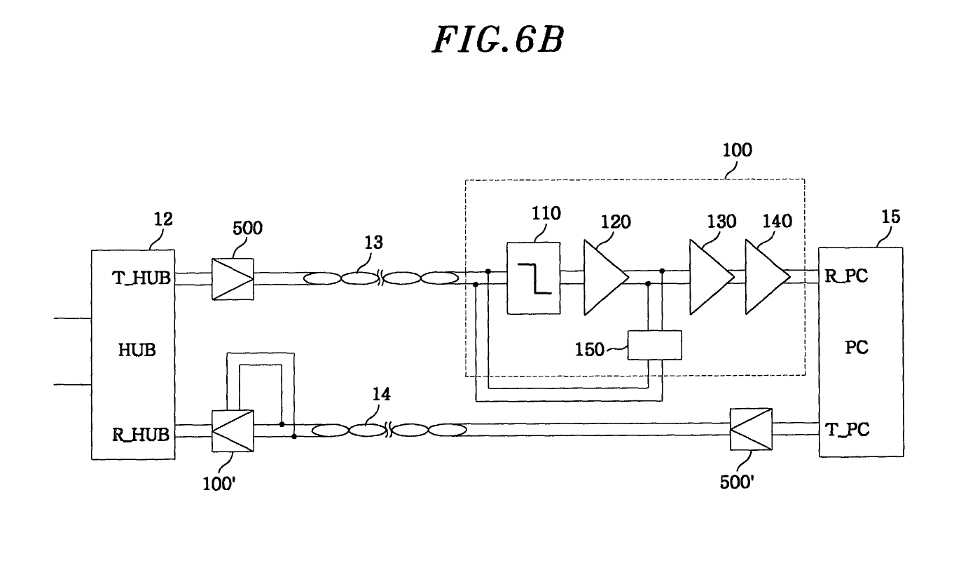

FIG. 6A shows a detailed block diagram in accordance with a fifth embodiment of the present invention, which is different from the block diagram of FIG. 4A in that linkage positions of the download and the upload signal processing amplifiers 100 and 100′ differ from those of the download and the upload signal processing amplifiers 100 and 100′ shown in FIG. 4A.

That is, the regulator 150 in the download signal processing amplifier 100 is linked to the download transmission line 13 at a position in front of the input terminal of the download signal processing amplifier 100. The upload signal processing amplifier 100′ is also linked to the upload transmission line 14 at a position in front of the input terminal of the upload signal processing amplifier 100′. Such an inventive architecture is used for a case that the crosstalk between a pair of transmission lines is negligible, thereby relieving the over-compensations of the download and the upload signal processing amplifiers 100 and 100′, which may occur in the short haul communication.

A transmission line has a characteristic that a signal is attenuated in proportion to a length of the transmission line. Therefore, the attenuation of the download signal is hardly detectable when the length of the download transmission line 13 is short. If the amplification gain of the download signal processing amplifier 100 is fixed at so high a level as to be suitable for the long distance, the download signals may be excessively amplified in the download signal processing amplifier 100. In this case, when the download signals attenuated to a slight degree are inputted into the regulator 150, the regulator 150 recognizes them as the branch signals S1, the magnitude of which is relatively large, to thereby lessen each amplification gain of the next stages. Therefore, this system can transmit the data in the long haul communication as well as the short haul communication.

FIG. 6B shows a block diagram of the 4-wire data communications system in accordance with a sixth preferred embodiment of the present invention, which further includes two output amplifiers 500 and 500′ in addition to the system shown in FIG. 6A. The output amplifiers 500 and 500′ are installed on the transmission lines at positions close to T_HUB and T_PC, respectively. This system is used for the same purpose as the system shown in the FIG. 6A.

Meanwhile, if both the magnitude of the crosstalk and the length of the transmission lines should be considered, it is better to combine the architectures of FIGS. 4A and 4B and those of FIGS. 6A and 6B into single one.

All of the explanations on the inventive system are given for the download signal processing amplifier 100 connected to the PC 15. However, it will be apparent to those skilled in the art that the operation of the upload signal processing amplifier 100′ connected to the hub 12 is similar to that of the download signal processing amplifier 100.

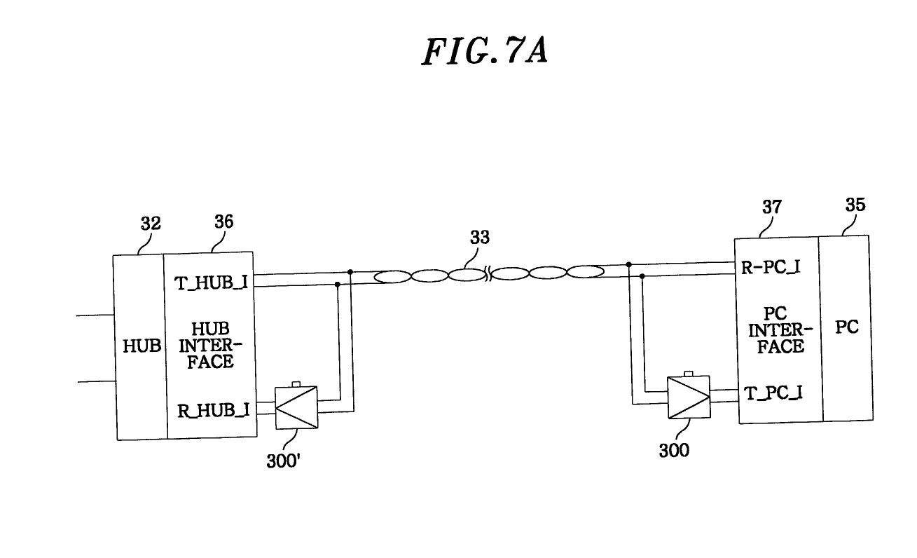

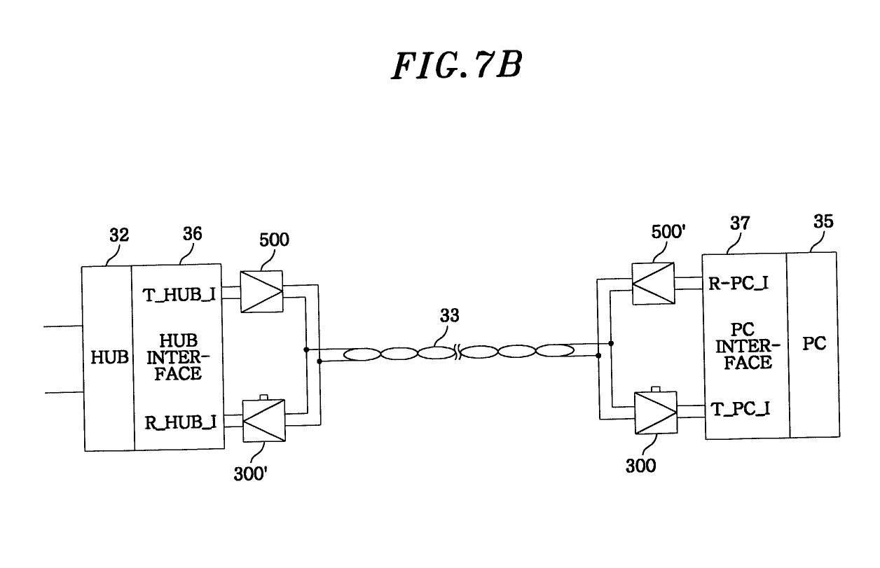

FIG. 7A shows a detailed block diagram of a 2-wire data communications system in accordance with a seventh preferred embodiment of the present invention, which includes a hub 32, a pair of transmission lines 33, a PC 35, a hub interface 36, a PC interface 37 and a download and an upload signal processing amplifiers 300 and 300′.

The hub 32 is connected to a main unit (not shown) to intermediate communication between the main unit and the PC 35. The hub 32 is also connected to the hub interface 36. The PC 35, which the PC interface 37 is connected to, communicates with the main unit through the transmission line 33 as a conventional subscriber.

The hub interface 36 has a transmission port T_HUB_I for sending download signals to the PC 35 and a reception port R_HUB_I for receiving upload signals generated from the PC 35. The PC interface 37 similarly has a transmission port T_PC_I for sending the upload signals to the main unit and a reception port R_PC_I for receiving the download signals.

The hub interface 36 and the PC interface 37 arrange the bidirectional transmission of signals, so that the download and the upload signals do not interfere with each other. That is, the download signals move along toward the PC 35 and the upload signals move along toward the hub 32 by two interfaces 36 and 37. In addition, the hub interface 36 and the PC interface 37 can reject crosstalk.

The transmission line 33 has a double channel for transmission and reception. That is, the transmission line 33 transmits both the download and the upload signals bidirectionally therethrough.

The download and the upload signal processing amplifiers 300 and 300′ enable data communication to be smoothly and exactly performed in the 2-wire data communications system.

The download signal processing amplifier 300 is located at a receiving end of the transmission line 33 close to R_PC_I and the upload signal processing amplifier 300′ is located at another receiving end of the transmission line 33 close to R_HUB_I. The input ports of the download and the upload signal processing amplifiers 300 and 300′ are linked to the transmission line 33, and their output ports are connected to R_PC_I and R_HUB_I, respectively. However, since the hub interface 36 and the PC interface 37 in the 2-wire data communications system can resolve the crosstalk, it is unnecessary to link the download and the upload signal processing amplifiers 300 and 300′ to the transmission line 33 in any position except where the input ports thereof are linked.

FIG. 7B shows a detailed block diagram of a 2-wire data communications system in accordance with an eighth preferred embodiment of the present invention, which further includes two output amplifiers 500 and 500′ in addition to the system shown in FIG. 7A. The output amplifier 500 is installed on the transmission line 33 at a position close to T_HUB_I and the output amplifier 500′ is installed on the transmission line 33 at a position close to T_PC_I. The output amplifiers 500 and 500′ enable the download and upload signals to be sent over the long haul by amplifying the signals therein.

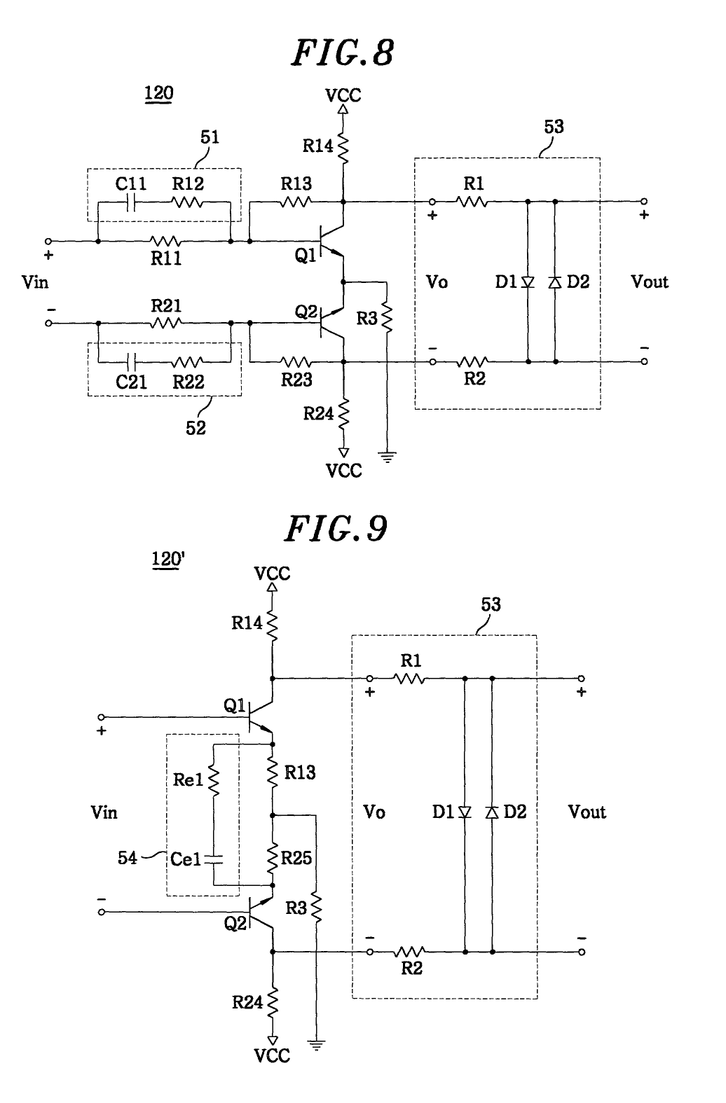

FIG. 8 shows a circuit diagram of the phase compensation amplifier 120 in accordance with the present invention. The phase compensation amplifier 120 includes two transistors Q1 and Q2, two diodes D1 and D2, a plurality of resistors and capacitors.

The transistors Q1 and Q2 act as a differential amplifier, and resistors R13 and R23 are connected thereto, to thereby make up a voltage-shunt feedback circuit. Without the sub-blocks 51, 52 and 53, the whole circuit as shown in FIG. 8 is a simple voltage-shunt feedback circuit. An amplification gain Av of the simple voltage-shunt feedback circuit is calculated as follows.

Av=Vout/Vin=−(R13/R11+R23/R21) (1)

As known from the Equation (1), the amplification gain Av is not a frequency function. Thus Av is approximately constant within a frequency band of the input signal, the frequency of which is not too high. However, the characteristic of the transmission lines practically causes the voltage gain to be degraded. Therefore, the phase compensation amplifier 120 needs a special scheme for compensating for the attenuation in the high frequency signal.

In order to compensate for the attenuation in the input signal, two sub-blocks 51 and 52 are connected to the main circuit in shunt, each of which includes a resistor and a capacitor connected in series. Then, the amplification gain of a circuit employing the sub-blocks 51 and 52 increases in proportion to the frequency of the input signal. That is, each of capacitors C11 and C21 in the sub-blocks 51 and 52 compensates for the attenuation in the high frequency signal. However, this causes the feedback circuit to be unstable. Accordingly, each of resistors R12 and R22 is connected in series to each of the capacitors C11 and C21 respectively in the sub-blocks 51 and 52, to thereby stabilize the feedback circuit.

Meanwhile, as stated above, if the amplification gain is adjusted to be excessively high, the input signal may be excessively amplified. Accordingly, the sub-block 53 is connected to output ports of the main circuit so as to prepare for that each amplification gain of the phase compensation amplifiers 120, 130 and 140 is designed to be very high.

The sub-block 53 shows a limiter circuit implemented with two resistors R1 and R2 and two diodes D1 and D2. The limiter circuit clips the input signal, the voltage of which is out of the predetermined range. That is, the signals are clipped to cut-in voltages of the diodes D1 and D2, i.e., V_{D1} and V_{D2}. Since amplitude of the input signal lies between the two thresholds, this limiter circuit can be used to prevent the download signals from being over-compensated in a subsequent stage.

FIG. 9 shows a detailed circuit diagram of another phase compensation amplifier 120′ in accordance with the present invention, which includes two transistors Q1 and Q2, two diodes D1 and D2, and a plurality of resistors and capacitances. Two transistors Q1 and Q2 operate as a differential amplifier, and resistors R15 and R25 are connected thereto, to thereby make up a current-series feedback circuit, which is different from the voltage-shunt feedback circuit of FIG. 8. The current-series feedback circuit has an impedance greater than that of the voltage-shunt feedback circuit of FIG. 8. A main circuit without sub-blocks 53 and 54 is a simple current-series feedback circuit. An amplification gain Av of the simple current-series feedback circuit is calculated as follows.

Av=−(R14+R24)/(R15+R25) (2)

As known from Equation (2), Av is not a frequency function and is constant within a frequency band of the input signal, the frequency of which is not too high. However, the characteristic of the transmission lines practically causes the voltage gain to be degraded.

Accordingly, the sub-block 54, which shows a circuit including a resistor Re1 and a capacitor Ce1 connected in series, is connected to bases of the differential amplifier, to thereby compensate for the attenuation in the high frequency signal.

The sub-block 53 prevents the download signals from being over-compensated in a subsequent stage like as the sub-block 53 in FIG. 8, in case that an amplification gain of the subsequent stage is designed to be too high.

Referring to FIG. 3A, the download signal processing amplifier 100 employs three phase compensation amplifiers 120, 130 and 140. As mentioned above, the phase compensation amplifiers 120, 130 and 140 are all of the same circuits for performing compensation such as amplification and limitation, and additional phase compensation amplifier can be inserted in the download signal processing amplifier 100. Such an architecture enables digital communication over long haul. However, it may cause communication failure due to over-amplification. Thus, the number of phase compensation amplifier to be used depends on the communication distance. The phase compensation amplifier can be implemented with either of the circuits shown in FIG. 8 and FIG. 9.

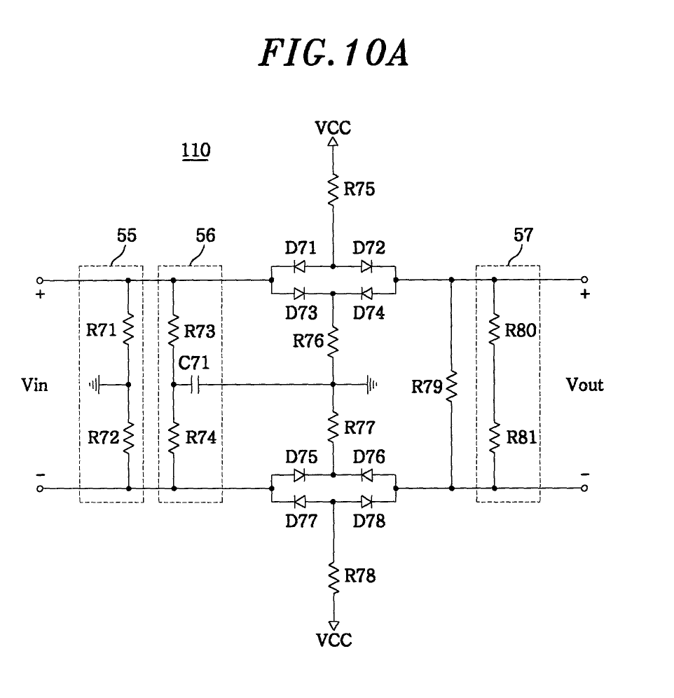

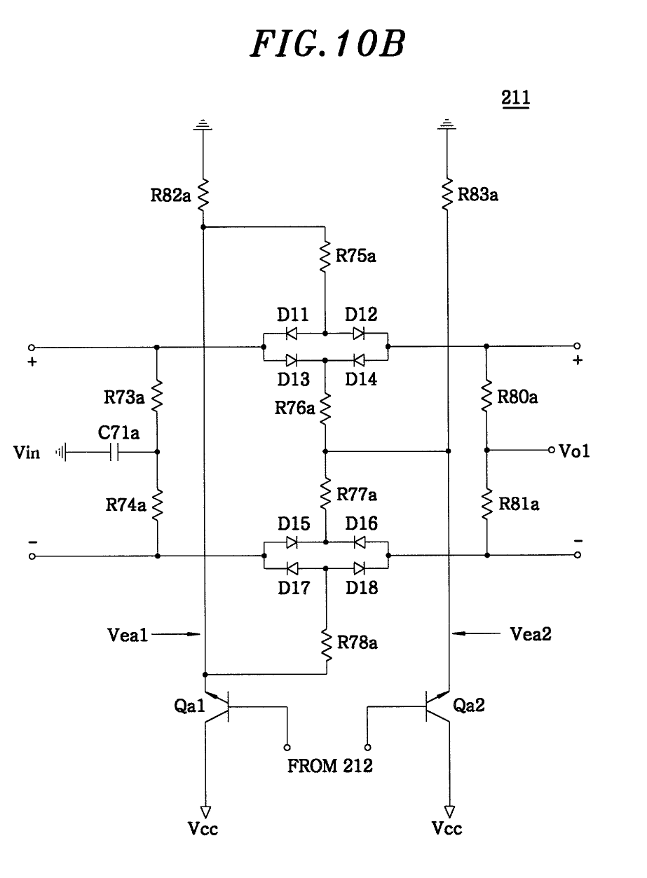

FIG. 10A shows a circuit diagram of the limiter 110 in accordance with the present invention. The limiter 110 includes a capacitance C71, a multiplicity of resistors R71 to R81 and two bridge diode circuits containing a plurality of bridge diodes D71 to D78.

Two bridge diode circuits form a main circuit with resistors R75 to R78. Each bridge diode circuit is biased by Vcc and is grounded via each resistor R76 and R77. When an AC input signal, Vin, is inputted into the main circuit, the main circuit clamps Vin within Vmax calculated from Equation (3) and then transmits the clamped signal to a subsequent stage. Herein, Vmax is calculated as follow.

Vmax=(Vcc−2Vd)R79/(R75+R76+R79) (3)

, wherein a forward voltage of a diode, Vd, is about 0.6V and it is assumed that each resistance of R75 and R76 equals each resistance of R78 and R77, respectively.

Meanwhile, a diode is not ideal to be used in switching. Such switching characteristic induces a reverse recovery current, which may bring about a system error. Accordingly, in order to prevent the reverse recovery current, two sub-blocks 55 and 57 are attached to the main circuit in parallel. Each of the sub-blocks 55 and 57 contains two resistors. If a large DC bias signal is applied into only one of four diodes in each bridge diode circuit, a small signal is biased into the rest of them. Then the reverse recovery current for a large AC input signal can be reduced. Herein, either of the sub-blocks 55 and 57 can be removed.

Meanwhile, the sub-block 56 shows a circuit for impedance matching and common mode signal rejection, which has R73 and R74 connected in series to each other and a capacitor C71, wherein R73 and R74 are determined according to the impedance of the transmission lines to adequately adjust the impedance of the limiter 110. The sub-block 56 is connected in shunt between the sub-block 55 and the main circuit. The sub-block 56 is grounded via C71 branching between R73 and R74, which rejects the common mode component, particularly, high frequency component in Vin.

FIG. 10B shows a circuit diagram of the limiter 211 in accordance with the present invention. The limiter 211 includes two sets of bridge diode circuits, two transistors QA1 and QA2, a capacitor C71A and a plurality of resistors R73A to R78A and R80A to R83A.

In two transistors QA1 and QA2, their collectors are connected to Vcc, their bases receive either control signal S4 or S5 from the controller 212, and their emitters are respectively coupled to resistors R75A and R78A, herein the control signal S4 and S5 will be explained later. Presuming a collector-emitter voltage of the transistor QA1 to Vea1 and that of the transistor QA2 to Vea2, the control signal S4 or S5, which is fed to QA1 and QA2 as base currents, controls Vea1 and Vea2. That is, if the control signal S4 is inputted thereto, then Vea1>Vea2 and an input signal Vin is converted to an output Vo1, which is clamped when its value is large and attenuated when its value is small. While, in case that the control signal S5 is inputted thereto, Vea1≦Vea2, no signal can pass through the bridge diode circuit and so the input signal Vin is cut off.

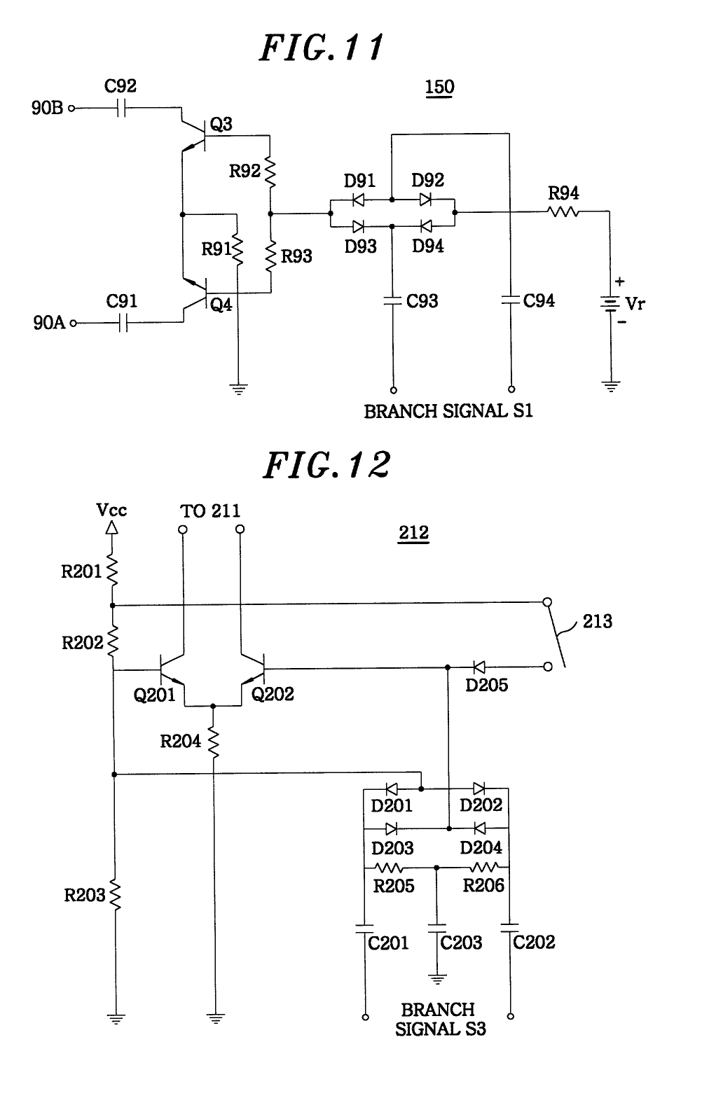

FIG. 11 shows a circuit diagram of the regulator 150 shown in FIG. 3 in accordance with the present invention. The circuit includes two transistors Q3 and Q4, a bridge diode circuit and a plurality of resistors R91 to R94 and capacitors C91 to C94.

When, for example, upload signals are outputted from T_PC, the regulator 150 detects a branch signal S1, which is a noise or a portion of the upload signals. The branch signal S1 is rectified in the bridge diode circuit and then moves along toward the bases of Q3 and Q4 via R92 and R93. Accordingly, output ports of the regulator 150, 90A and 90B output a control signal S2. That is, when high frequency signal is inputted thereto, Q3 and Q4 are actuated and then generate a control signal S2 in proportion to the magnitude of the branch signal S1. The control signal S2 is provided to a subsequent stage via C91 and C92 to thereby decrease the magnitude of the high frequency signal.

Herein, R91 and R94 adjust the magnitude of current, and Vr, an auxiliary voltage source, is a DC voltage source for biasing the bridge diodes D91 to D94, and the transistors Q3 and Q4.

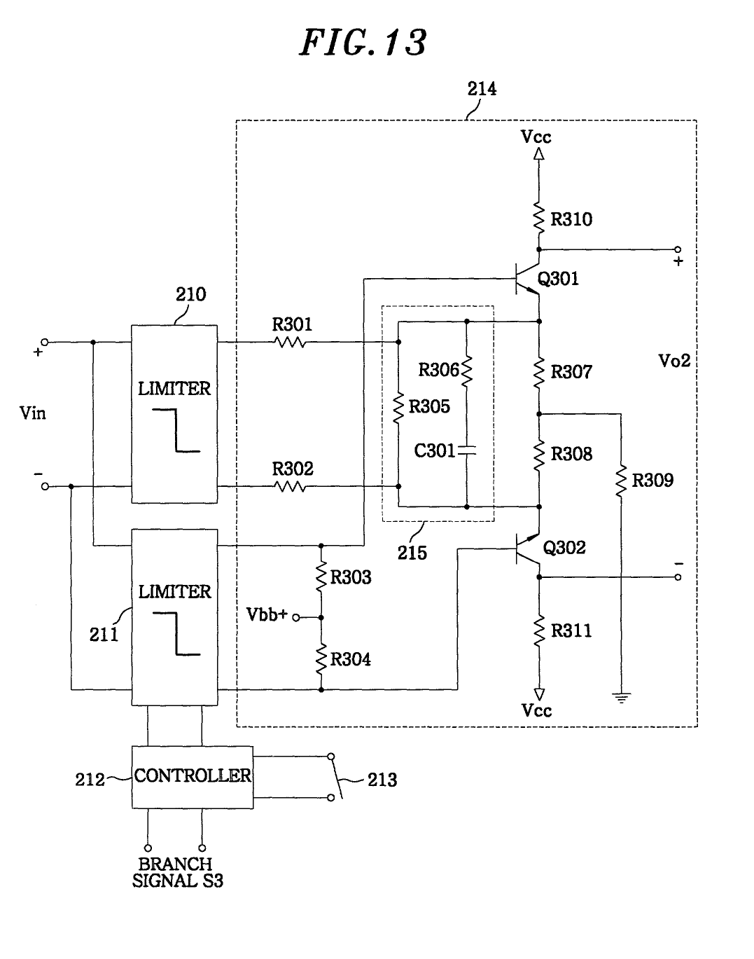

FIG. 12 shows a circuit diagram of the controller 212 in accordance with the present invention. The controller 212 includes a bridge diode circuit, two transistors Q201 and Q202, a diode D205, and a plurality of resistors R201 to R206 and capacitors C201 to C203.

Two transistors Q201 and Q202 operate as a differential amplifier. Their collectors, as output ports of the controller 212, are connected to an input port of the limiter 211 and their emitters are connected to a common resistor R204 for bias current to move along. A base of Q202 is connected to an output port between D203 and D204 in the bridge diode circuit, wherein the output port of the bridge diode circuit is connected to a switch 213 via D205. A base of Q201 is connected to the other output between D201 and D202 in the bridge diode circuit, wherein the output of the bridge diode circuit is between R202 and R203 for biasing Vcc.

The bridge diode circuit, input ports of which are respectively connected to capacitors C201 and C202, has four diodes D201 to D204. Also, two resistors R205 and R206 connected in series are connected parallel to the input ports of the bridge diode circuit and a capacitor C203 which branches therebetween is grounded, to thereby reject any high frequency common component of the branch signal S3. And output ports of the bridge diode circuit are connected to bases of the differential amplifier.

Meanwhile, the controller 212 further includes a switch 213 to be used in selecting control signal S4 or S5 for deciding an operation of the limiter 211.

Hereinafter, the operation of the controller 212 is explained.

First, in case of the short haul communication, the switch 213 is off as stated above and the limiter 211 operates as follows. If the branch signal S3 is detected in the output ports of the bridge diode circuit, Q202 is actuated and Q201 is cut-off. Accordingly, the control signal S4 generated from Q201 and Q202 is provided to the limiter 211, so that Vea1 is smaller than Vea2 in the limiter 211, to thereby disenable the limiter 211. While, if the branch signal S3 is not detected therein, Q201 is biased and Q202 is not biased. Therefore, Q201 is actuated and Q202 becomes cut-off, so that the control signal S5 makes that Vea1 of the limiter 211 greater than Vea2, thereby activating the limiter 211.

On the contrary, the switch 213 is on in case of the long haul communication. When the switch is on, Q202 always stays at an actuated state regardless of the detection of the branch signal S3, and Q201 becomes cut-off. Therefore, Vea1 is smaller than Vea2 in the limiter 211, to thereby disenable the limiter 211.

Herein, R202 has a resistance value for satisfying the above condition. Such an operation can reduce the crosstalk as mentioned above.

FIG. 13 shows a circuit diagram of the signal combination unit 214 in accordance with the present invention. This circuit is implemented with two transistors Q301 and Q302, a capacitor C301 and a plurality of resistors R301 to R311.

The signal combination unit 214 receives download signals through two paths. That is, the signal combination unit 214 has two pairs of input ports, wherein a first pair of input ports receives as a single input port the download signals provided from the limiter 210 through the first path; and a second pair of input ports receives as the other single port the download signals provided from the limiter 211 through the second path.

Each input port of the first pair is connected in series to a resistor, i.e., R301 and R302. R303 and R304, each of which branches between the second pair and the limiter 211, are coupled to Vbb for biasing the differential amplifier.

Two transistors Q301 and Q302 act as a differential amplifier, wherein their collectors are connected to Vcc via resistors R310 and R311 respectively; their emitters are connected to the first input ports; and their bases are connected to the second input ports.

A regulating unit 215 and an output load circuit are located between the emitters of the differential amplifier. The regulating unit 215 shows a circuit, in which R306 and C301 connected in series to each other are connected parallel to R305. The output load circuit is a circuit, in which R307 and R308 are connected in series to each other, connected parallel to the regulating unit 215. Herein, the output load circuit is grounded through R309 which branches between R307 and R308.

Referring to FIG. 13, the download signals on the first path are directly coupled to emitters of Q301 and Q302 via R301 and R302. Since a collector voltage of Q301 is almost equal to an emitter voltage thereof because of low impedance in the transistors Q301 and Q302, an output voltage Vo2A for the first path is approximately the same as an emitter-emitter voltage between Q301 and Q302. Therefore, an amplification gain from the first path can be varied by changing the resistance of each R301 and R302.

Meanwhile, the download signals on the second path are inputted into the bases of the differential amplifier. The download signals applied into each base of Q301 and Q302 control the magnitudes of emitter current and collector voltage thereof. Accordingly, Vo2B is in proportion to the download signals on the second path, so that a phase of Vo2B is inverted and gain thereof is significantly amplified. Herein, the download signals through the second path pass the regulating unit 215 via the bases of the differential amplifier, while the download signals through the first path do not. The regulating unit 215 makes the amplification gain for the download signals through the second path represented as a frequency function.

Meanwhile, Vo2A and Vo2B are superposed on each other, to thereby represent an output signal Vo2 of the signal combination unit 214.

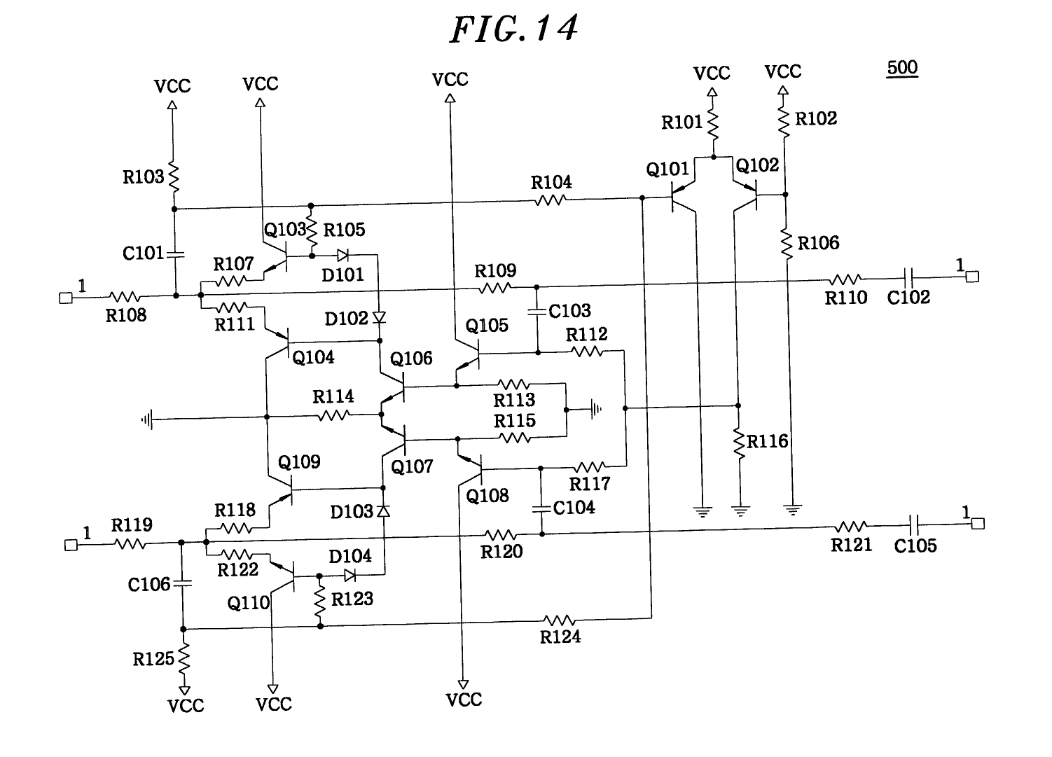

FIG. 14 shows a circuit diagram of the download signal output amplifier 500 in accordance with the present invention, which includes a multiplicity of transistors Q101 to Q110, diodes D101 to D104, capacitors C101 to C106 and resistors R101 to 124.

Two transistors Q105 and Q108 are input buffers, and four transistors Q103, Q014, Q109 and Q110 are output buffers. Two transistors Q106 and Q107 act as a differential amplifier, and two transistors Q101 and Q102 become a common mode feedback circuit for maintaining a constant DC in output terminals. Herein, a closed loop voltage gain for high frequency AC signal in the circuit is calculated as follows.

Av=−(R109+R120)/(R110+R121) (4)

An impedance of the output, Zout, is approximately calculated as follows.

Zout=R108+R110 (5)

The impedance matching is realized by setting Zout to the impedance of the transmission line.

Herein, it will be apparent to those skilled in the art that the upload signal output amplifier 500′ performs the same operation as the download signal output amplifier 500.

While the invention has been shown and described with respect to the preferred embodiments, it will be understood by those skilled in the art that various changes and modifications may be made without departing from the spirit and scope of the invention as defined in the following claims.

What is claimed is:

1. A data communications system, which comprises:
a first node for transmitting an output digital signal to a second node through a transmission line and receiving an input digital signal from the second node through a reception line, wherein the first node having a transmission port for transmitting the output digital signal and a reception port for receiving the input digital signal; and
a signal processing amplification block for compensating an attenuation of the input digital signal and preventing a crosstalk between the transmission line and the reception line, wherein an input port of the signal processing amplification block is connected to the second node through the reception line and an output port of the signal processing amplification block is connected to the reception port.

2. The data communications system of claim 1, wherein the signal processing amplification block includes:
a limiting circuit for clamping the input digital signal to make it fall within a predetermined range;
a phase compensation amplification circuit for amplifying the clamped digital signal; and
a regulating circuit for rectifying a branch signal and generating a control signal to alter an amplification gain of the phase compensation amplification circuit, based on a length of the reception/transmission line and a capacity of the branch signal, the branch signal being a portion of the output digital signal, a portion of the input digital signal or a noise signal.

3. The data communications system of claim 2, wherein the limiting circuit has:
a circuit for matching an impedance of the input digital signal with an impedance of the reception line and rejecting a common mode component of the input digital signal; and
a circuit for rejecting a reverse recovery current occurred in operation of the limiting circuit.

4. The data communications system of claim 2, wherein the phase compensation amplification circuit has:
a circuit for controlling an amplification gain of the phase compensation amplification circuits in proportion to a frequency of the clamped digital signal, and preventing the amplification gain from being out of a predetermined range;
a differential amplifier circuit for amplifying the clamped digital signal; and
a circuit for clamping the amplified digital signal from the differential amplifier circuit to make it fall within a predetermined range.

5. The data communications system of claim 2, wherein an input end of the regulating circuit is linked to the transmission port or the transmission line at a position close to the transmission port, to thereby rectify the portion of the output digital signal or the noise signal and generate the control signal.

6. The data communications system of claim 2, wherein an input end of the regulating circuit is linked to the reception line at a position close to the input port of the signal processing amplification block, to thereby rectify the portion of the input digital signal or the noise signal and generate the control signal.

7. The data communications system of claim 1, wherein the signal processing amplification block includes:
a first limiting circuit for clamping the input digital signal to make it fall within a predetermined range;
a second limiting circuit for generating an output signal under a control of a control signal from a control circuit;
the control circuit for generating the control signal to activate the second limiting circuit to pass the clamped digital signal as the output signal based on a length of the reception/transmission line and a capacity of a branch signal, the branch signal being a portion of the output digital signal, a portion of the input digital signal or a noise signal;
a signal combination circuit for superposing the output signal from the second limiting circuit on the clamped digital signal from the first limiting circuit to generate a superposed signal; and
a phase compensation amplification circuit for amplifying the superposed signal.

8. The data communications system of claim 7, wherein the first limiting circuit has:
a circuit for matching an impedance of the input digital signal with an impedance of the reception line and rejecting a common mode component of the input digital signal; and
a circuit for rejecting a reverse recovery current occurred in operation of the first limiting circuit.

9. The data communications system of claim 7, wherein the signal combination circuit has a regulating unit for adjusting an amplification gain for the output signal from the second limiting circuit in proportion to a frequency of the output signal.

10. The data communications system of claim 7, wherein the phase compensation amplification circuit has:
a circuit for controlling an amplification gain of the phase compensation amplification circuit in proportion to a frequency of the superposed signal, and preventing the amplification gain from being out of a predetermined range;
a differential amplifier circuit for amplifying the superposed signal; and
a circuit for clamping the superposed signal from the differential amplifier circuit to make it fall within a predetermined range.

11. The data communications system of claim 1, which further comprises an output signal amplification circuit for compensating the attenuation of the output digital signal, wherein an input port of the output signal amplification circuit is connected to the first node through the transmission line and an output port of the output signal amplification circuit is connected to the second node.

12. The data communications system of claim 11, wherein the output signal amplification circuit matches an output impedance thereof with an impedance of the transmission line.

13. A data communications system, which comprises:
a first node for transmitting an output digital signal to a second node through a transmission line and receiving an input digital signal from the second node through a reception line, wherein the first node having a transmission port for transmitting the output digital signal and a reception port for receiving the input digital signal;
an amplification device for amplifying the input digital signal, wherein an input port of the amplification device is connected to the second node through the reception line and an output port of the amplification device is connected to the reception port; and
a regulating block, coupled to the amplification device, for generating a control signal to alter an amplification gain of the amplification device, to thereby prevent a crosstalk between the transmission line and the reception line.

14. The data communications system of claim 13, wherein the regulating block includes:
a circuit for rectifying the portion of the output digital signal or the noise signal; and
a circuit for generating the control signal based on a capacity of the rectified signal to transmit the control signal to the amplification device.

15. The data communications system of claim 14, wherein an input end of the regulation block is linked to the transmission port or the transmission line at a position close to the transmission port.

16. The data communications system of claim 13, wherein the regulating block includes:
a circuit for rectifying the portion of the input digital signal or the noise signal; and
a circuit for generating the control signal based on a capacity of the rectified signal to transmit the control signal to the amplification device.

17. The data communications system of claim 16, wherein an input end of the regulating block is linked to the reception line at a position close to the input port of the amplification device.
